(19) United States
(12) Patent Application Publication
(10) Pub. No.: US 2023/0177860 A1
(43) Pub. Date: Jun. 8, 2023

(54) MAIN OBJECT DETERMINATION APPARATUS, IMAGE CAPTURING APPARATUS, AND METHOD FOR CONTROLLING MAIN OBJECT DETERMINATION APPARATUS

(71) Applicant: CANON KABUSHIKI KAISHA, Tokyo (JP)

(72) Inventors: Reiji Hasegawa, Kanagawa (JP); Tomohiro Nishiyama, Tokyo (JP)

(21) Appl. No.: 18/061,358

(22) Filed: Dec. 2, 2022

(30) Foreign Application Priority Data
Dec. 7, 2021 (JP) 2021-198650

(51) Int. Cl. G06V 40/10; G06V 10/62

(52) U.S. Cl. CPC G06V 40/10; G06V 10/62

(57) ABSTRACT

A main object determination apparatus includes an acquisition unit configured to acquire images captured at different timings, a selection unit configured to select a candidate of a main object from among objects using information about a feature point of each object in the images, and a determination unit configured to determine whether candidates of the main object selected at the different timings are the same using the information, wherein the main object is determined in a case where the determination unit determines that the candidates of the main object selected by the selection unit in an image of interest and in at least one image captured within a predetermined period of time before the image of interest is captured are the same.

### BACKGROUND OF THE DISCLOSURE

### Field of the Disclosure

The present disclosure relates to a technique for estimating an object and determining a main object based on an estimation result.

### Description of the Related Art

Conventionally, various techniques for detecting an object to be a control target have been discussed in order to perform imaging control such as auto focus (AF) in an image capturing apparatus such as a digital camera.

In Japanese Unexamined Patent Application Publication (Translation of PCT Application) No. 2018-538631, a technique for simultaneously tracking a plurality of persons and inputting time-series data into a recurrent neural network to simultaneously estimate types of actions and positions of the persons is discussed as an action recognition technique targeted at a plurality of persons.

However, in Japanese Unexamined Patent Application Publication (Translation of PCT Application) No. 2018-538631, the technique involves simultaneous tracking of a plurality of objects and requires the recurrent neural network. Thus, a high processing load is imposed on hardware of an image capturing apparatus or the like if the technique is installed therein.

There is a need in the art for a technique for highly accurately determining a main object that is highly likely to match a user’s intention in an image in which a plurality of objects exists while reducing a processing load.

### SUMMARY OF THE DISCLOSURE

According to an aspect of the present disclosure, a main object determination apparatus includes one or more processors, and a memory storing instructions which, when executed by the one or more processors, cause the main object determination apparatus to function as an acquisition unit configured to acquire images captured at different timings, a selection unit configured to select a candidate of a main object from among objects using information about a feature point of each object in the images, and a determination unit configured to determine whether candidates of the main object selected at the different timings are the same using information about a feature amount calculated from the feature point, wherein the main object is determined in a case where the determination unit determines that the candidates of the main object selected by the selection unit in an image of interest and in at least one image captured within a predetermined period of time before the image of interest is captured are the same.

According to another aspect of the present disclosure, a main object determination apparatus includes one or more processors, and a memory storing instructions which, when executed by the one or more processors, cause the main object determination apparatus to function as an acquisition unit configured to acquire images captured at different timings, a selection unit configured to select a candidate of a main object from among objects in the images, and a determination unit configured to determine whether candidates of the main object selected at the different timings are the same, wherein the main object is determined in a case where the selection unit selects the candidate of the main object in at least one image captured within a predetermined period of time before an image of interest is captured and the determination unit determines that the candidate of the main object in the image captured within the predetermined period of time is the same as the candidate of the main object in the image of interest.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of an image capturing apparatus including a main object determination apparatus.

FIG. 2 is a block diagram illustrating a part of a detailed configuration of an image processing unit according to a first exemplary embodiment.

FIG. 3 is a flowchart illustrating main object determination processing according to the first exemplary embodiment.

FIGS. 4A and 4B are conceptual diagrams of information acquired by a posture acquisition unit.

FIGS. 5A and 5B illustrate examples of processing target images in different frames.

FIG. 6 is a flowchart illustrating main object determination processing according to a third exemplary embodiment.

FIG. 7 illustrates an example of main object candidates according to a second exemplary embodiment.

### DESCRIPTION OF THE EMBODIMENTS

Exemplary embodiments of the present disclosure will be described in detail below with reference to the attached drawings. However, the following exemplary embodiments are not intended to limit the present disclosure set forth in the claims. In the exemplary embodiments, a plurality of features is described, but not all of the features described in the exemplary embodiments are essential for solving means of the present disclosure, and the plurality of features may be freely combined with each other. Identical or similar components are denoted by the same reference numerals in the attached drawings, and duplicate descriptions thereof are omitted.

### Overall Configuration of Image Capturing Apparatus 100

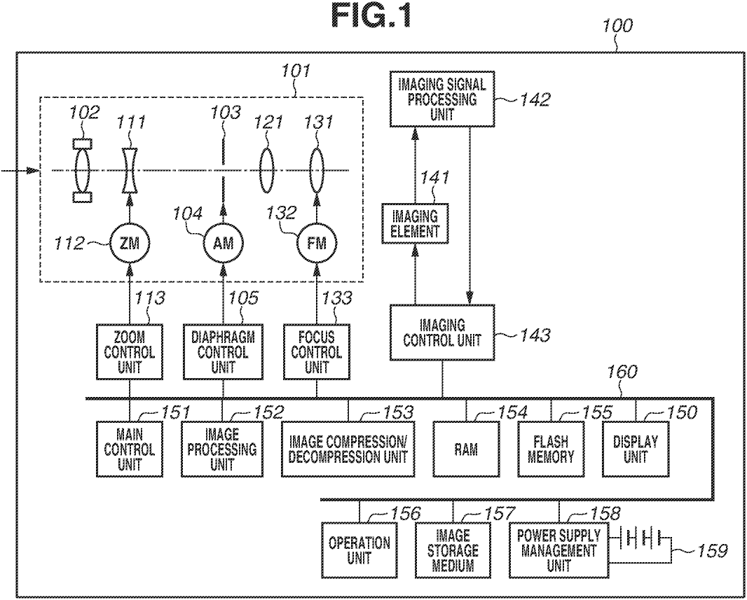

FIG. 1 is a block diagram illustrating a configuration of an image capturing apparatus 100 that includes a main object determination apparatus. The image capturing apparatus 100 is a digital still camera or a video camera that captures an image of an object and records data of a still image or a moving image on various media such as a tape, a solid-state memory, an optical disk, and a magnetic disk, but the image capturing apparatus 100 is not limited to them. For example, the present disclosure can be applied to a device that incorporates or externally connects to an image capturing apparatus, such as a mobile phone (a smartphone), a personal computer such as a laptop type, desktop type, or tablet type PC, a game console, an on-vehicle sensor, a factory automation (FA) device, a drone, or a medical device. Thus, “an image capturing apparatus” in the present specification is intended to encompass an electronic device that has an image capturing function. Further, the “main object determination apparatus” in the present specification is intended to encompass an electronic device that determines a main object based on an image captured by the image capturing apparatus.

A case where the object is a person is described below as an example. The main object refers to an object that is a target of imaging control intended by a user. A configuration illustrated in FIG. 1 is merely an example of the configuration of the image capturing apparatus 100.

Each unit in the image capturing apparatus 100 is connected with each other via a bus 160. Each unit is controlled by a main control unit 151.

A lens unit 101 is an imaging optical system that includes a first fixed lens group 102, a zoom lens 111, a diaphragm 103, a third fixed lens group 121, and a focus lens 131. A diaphragm control unit 105 drives the diaphragm 103 via an aperture motor (AM) 104 based on a command from the main control unit 151 to adjust an aperture diameter of the diaphragm 103 and to adjust a light amount during imaging.

A zoom control unit 113 drives the zoom lens 111 via a zoom motor (ZM) 112 to change a focal length. A focus control unit 133 determines a drive amount by which a focus motor (FM) 132 is driven based on a deviation amount of the lens unit 101 in a focusing direction. In addition, the focus control unit 133 drives the focus lens 131 via the FM 132 to control a focus adjustment state. The focus control unit 133 and the focus motor 132 implement auto focus (AF) control by controlling movement of the focus lens 131. The focus lens 131, which is a lens for adjusting the focus, is simply illustrated as a single lens in FIG. 1, but usually includes a plurality of lenses.

An object image formed on an imaging element 141 through the lens unit 101 is converted into an electric signal by the imaging element 141. The imaging element 141 is a photoelectric conversion element that photoelectrically converts an object image (an optical image) into an electrical signal. The imaging element 141 includes light receiving elements arranged so that there are m pixels in a horizontal direction and n pixels in a vertical direction. The image that is formed on and photoelectrically converted by the imaging element 141 is processed into an image signal (image data) by an imaging signal processing unit 142. Accordingly, an image on an imaging plane is acquired.

The image data output from the imaging signal processing unit 142 is transmitted to an imaging control unit 143 and temporarily stored in a random access memory (RAM) 154. The image data stored in the RAM 154 is compressed by an image compression/decompression unit 153 and then recorded in an image storage medium 157. In parallel with this processing, the image data stored in the RAM 154 is transmitted to an image processing unit 152.

The image processing unit 152 applies predetermined image processing to the image data stored in the RAM 154. The image processing applied by the image processing unit 152 includes, but is not limited to, development processing such as white balance adjustment processing, color interpolation (demosaicing) processing, and gamma correction processing, as well as signal format conversion processing and scaling processing. In a first exemplary embodiment, the image processing unit 152 selects a main object candidate based on position information of posture information (for example, a joint position) about an object. The image processing unit 152 may use a result of selection processing of the main object candidate in other image processing (for example, white balance adjustment processing). Further, the image processing unit 152 determines whether the main object candidates selected at different times are the same object. The image processing unit 152 stores the processed image data, the posture information about each object, and position information about the center of gravity, a face, and eyes of the main object candidate in the RAM 154. The image processing unit 152 also includes a tracking unit (not illustrated) and can perform tracking processing on an object or a specific area between images such as images during live view.

The tracking unit identifies an image area (an object area) to be tracked based on a designated position. For example, the tracking unit extracts a feature amount from an object area of an image in a certain frame of interest and searches through images successively supplied for an area with high similarity to the object area in the frame of interest as an object area using the extracted feature amount. Template matching, histogram matching, or a Kanade-Lucas-Tomasi (KLT) feature tracker method can be used as a method for searching for the area based on the feature amount of an image. Another method may be used as long as an object area can be searched for based on the feature amount. In addition to the above-described methods, the tracking unit may learn a convolutional neural network (CNN) for object tracking, input an image of a different frame to the CNN, and directly output an image area for tracking.

An operation unit 156 is an input interface including a button and the like. The user can perform various operations on the image capturing apparatus 100, such as changing an imaging mode and switching a method for object determination processing, which will be described below, by performing a selection operation on various function icons displayed on a display unit 150.

The main control unit 151 includes one or more programmable processors such as a central processing unit (CPU) and a micro processing unit (MPU). Further, the main control unit 151 loads a program stored in, for example, a flash memory 155 into the RAM 154, and executes the program to control each unit of the image capturing apparatus 100 and thus implement functions of the image capturing apparatus 100. The main control unit 151 also performs automatic exposure (AE) processing that automatically determines exposure conditions (a shutter speed or an accumulation time, an aperture value, and sensitivity) based on object luminance information. The object luminance information can be acquired from, for example, the image processing unit 152. The main control unit 151 can also determine the exposure condition based on an area of a specific object, such as a person’s face.

The focus control unit 133 performs AF control with respect to the position of the main object stored in the RAM 154. The diaphragm control unit 105 performs exposure control using a luminance value of the specific object area.

The display unit 150 displays an image and a detection result of the main object. A battery 159 is properly managed by a power supply management unit 158 and stably provides a power supply to the entire image capturing apparatus 100.

The flash memory 155 stores a control program necessary for an operation of the image capturing apparatus 100 and a parameter and the like used for an operation of each unit. If the image capturing apparatus 100 is started up by a user operation (shifted from a power-off state to a power-on state), the control program and the parameter stored in the flash memory 155 are read into a part of the RAM 154. The main control unit 151 controls the operation of the image capturing apparatus 100 based on the control program and a constant loaded into the RAM 154.

### Main Object Determination Processing

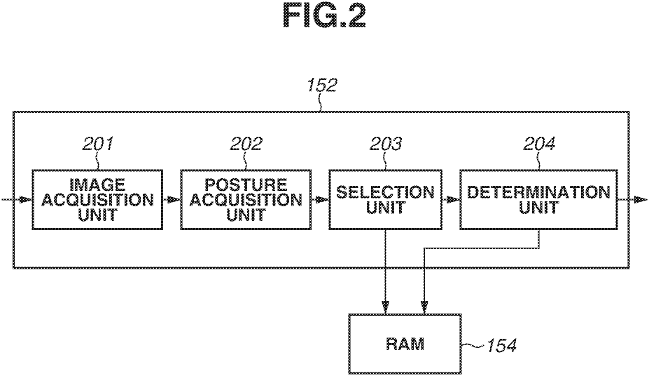

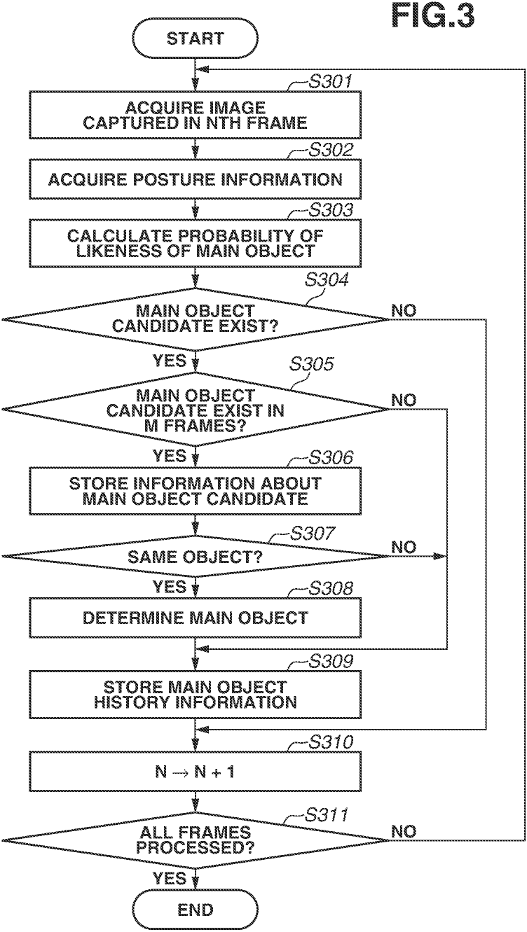

Main object determination processing executed by the image processing unit 152 is described with reference to FIGS. 2 and 3. FIG. 2 is a block diagram illustrating a part of a detailed configuration of the image processing unit 152. FIG. 3 is a flowchart illustrating the main object determination processing. The processing in each step in the present flowchart is implemented by each unit of the image processing unit 152 operating under the control of the main control unit 151, unless otherwise specified. In the following description, a scene where a plurality of players plays a sport is described as a target imaging scene for the main object determination processing, but an imaging scene to which the present exemplary embodiment can be applied is not limited to this one.

In step S301, an image acquisition unit 201 acquires an image captured in an Nth frame from the imaging control unit 143.

In step S302, a posture acquisition unit 202 detects an object (a person) in the image acquired by the image acquisition unit 201, estimates a posture of the detected object, and acquires posture information. The posture information is acquired by acquisition of a “joint position” described below from the detected object.

As a method for detecting the object and the joint position performed by the posture acquisition unit 202, for example, a trained model such as the CNN trained by machine learning may be used. In the object detection using the trained model, the posture acquisition unit 202 can detect the object using dictionary data for the object detection generated by the machine learning. To detect the object, dictionary data different for each specific object may be used, such as dictionary data for “persons” and dictionary data for “animals”. The posture acquisition unit 202 uses the dictionary data to detect the object and changes a content of subsequent posture estimation depending on which dictionary data has been used to detect the object. For example, in a case where the object detection is completed by using the dictionary data for “persons”, the posture estimation is performed so as to correspond to a “person”.

If the posture acquisition unit 202 completes the object detection, the posture acquisition unit 202 starts the posture estimation of the object depending on a type of the detected object. Here, a case where the detected object is a person is described as an example. The posture acquisition unit 202 first acquires positions of a plurality of joints of a person who is the object as feature points. Then, the posture acquisition unit 202 estimates the posture of the object based on information about the acquired joint positions. Any method, such as a method using deep learning, can be used for the posture estimation.

For an object detection method and a joint position detection method executed by the posture acquisition unit 202, a trained model other than the trained CNN may be used. For example, a trained model generated by the machine learning such as a support vector machine or a decision tree may be applied to the posture acquisition unit 202. The posture acquisition unit 202 does not have to use the trained model generated by the machine learning. For example, an object detection method and a joint position detection method that do not use the machine learning may be applied to the posture acquisition unit 202.

In step S303, a selection unit 203 calculates probability representing likeness of the main object for each object based on the posture information.

In step S304, the selection unit 203 determines whether the object to be the main object candidate exists, and in a case where the main object candidate exists (YES in step S304), the processing proceeds to step S305. A method for calculating the probability representing the likeness of the main object and a specific method for selecting the main object candidate are described below. In a case where the main object candidate does not exist (NO in step S304), the processing proceeds to step S310.

In step S305, a determination unit 204 refers to information in the RAM 154 and determines whether the main object candidate exists in images in N-Mth to N-1th frames captured at different timings from that of the Nth frame. In a case where the main object candidate exists (YES in step S305), the processing proceeds to step S306, whereas in a case where the main object candidate does not exist (NO in step S305), the processing proceeds to step S309. In a case of N = 1 (a first frame), there is no previous frame, and thus the processing proceeds to step S309 after the processing in step S305.

In step S306, the determination unit 204 stores information about one or a plurality of main object candidates in the RAM 154, and the processing proceeds to step S307.

In step S307, the determination unit 204 performs matching (same object determination) with the main object candidate in images in some frames that are temporally close to the Nth frame and in which the main object candidate is detected among the images in the N-Mth to N-1th frames. As a result of the matching, in a case where the main object candidate is determined as the same object (YES in step S307), the processing proceeds to step S308, and if not (NO in step S307), the processing proceeds to step S309.

It is desirable that the value M is adjusted so that M/f will be an appropriate time with respect to the imaging scene and the object, where f is a frame rate. For example, in a case where an object of interest performs a shooting action in a scene of a sport such as soccer, a time (delay time) from a preparatory action for shooting to a moment of the shooting (a shutter release opportunity) is generally about a few seconds. Thus, it is desirable that the value M is set so that the same object determination is completed before the shutter release opportunity and M/f is shorter than the delay time. Since the delay time until the shutter release opportunity is different depending on the imaging scene and the object, the determination unit 204 may switch the value M as necessary. Alternatively, the value M may be determined in advance by the user. Information about frames before the N-Mth frame is not used in the processing in step S307.

In step S308, the determination unit 204 determines the object that is determined as the same object as the main object and, in step S309, stores main object history information in the RAM 154.

In step S310, the determination unit 204 updates the Nth frame to an N+1th frame. In step S311, the determination unit 204 determines whether all frames are processed, and if not (NO in step S311), the processing returns to step S301.

### Posture Acquisition Unit and Selection Unit

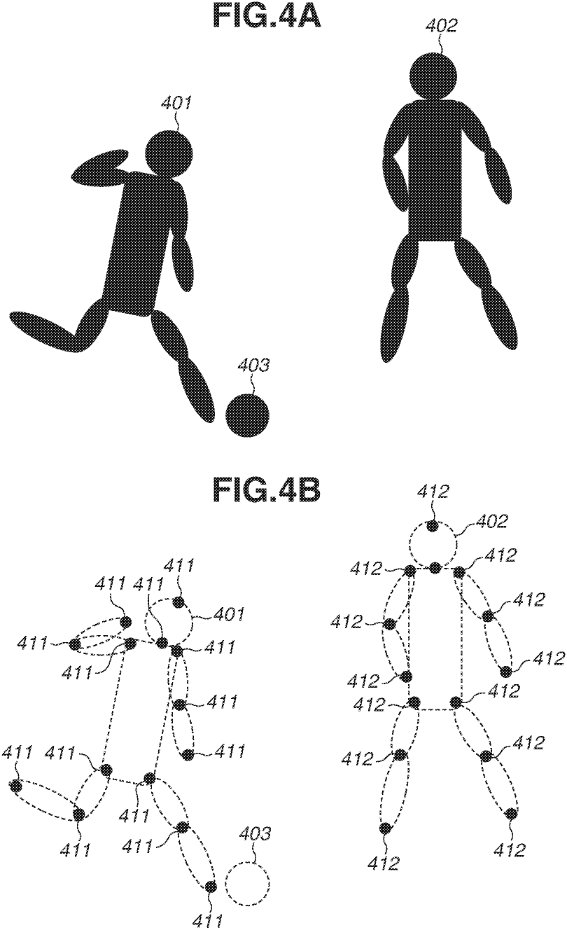

FIGS. 4A and 4B are conceptual diagrams of information acquired by the posture acquisition unit 202. FIG. 4A illustrates a processing target image in which an object 401 is about to kick a ball 403. The object 401 is an important object in the imaging scene. In the present exemplary embodiment, the selection unit 203 uses the posture information about the object acquired by the posture acquisition unit 202 to determine the object (the main object) that is highly likely to be intended by the user as a target for imaging control, monitoring (gazing), and the like. Meanwhile, an object 402 is a non-main object. The non-main object represents an object other than the main object.

FIG. 4B illustrates an example of the posture information about the objects 401 and 402. Joints 411 represent joints of the object 401, and joints 412 represent joints of the object 402. FIG. 4B illustrates an example where positions corresponding to a top of the head, a neck, shoulders, elbows, wrists, a hip, knees, and ankles are acquired as positions of joints (feature points). However, some of these positions or different positions may be acquired as the joint positions. Information about an axis connecting the joints or the like may be used for the posture estimation in addition to the joint positions.

In the following description, a case where the joint position is acquired as the posture information is described.

In step S302 in FIG. 3, the posture acquisition unit 202 acquires two-dimensional coordinates (x, y) of the joints 411 and the joints 412 in the images. The unit of the two-dimensional coordinates (x, y) is a pixel. The posture acquisition unit 202 estimates the posture of the object based on information about the acquired coordinates of the joints. Specifically, the posture acquisition unit 202 grasps a positional relationship of each joint position based on the information about the acquired coordinates of the joints and acquires the posture information estimated from the positional relationship. To estimate the posture of the object, a trained model other than the trained CNN may be used. For example, a trained model generated by the machine learning such as the support vector machine or the decision tree may be applied to the posture acquisition unit 202. The posture acquisition unit 202 does not have to use the trained model generated by the machine learning. For example, a posture estimation method that does not use the machine learning may be applied to the posture acquisition unit 202.

The description is returned to FIG. 3. In step S303, the selection unit 203 calculates reliability (probability) representing the likeness of the main object for each object based on the coordinates of the joints and the posture information acquired by the posture acquisition unit 202. A means of the machine learning such as the neural network, the support vector machine, or the decision tree can be used as a method for calculating the probability. In addition, instead of the machine learning, a function that outputs reliability or a probability value based on a certain model may be created as the method for calculating the probability. A learned weight and a bias value are stored in advance in the flash memory 155 and are stored in the RAM 154 as needed.

The selection unit 203 may calculate the reliability using data that is coordinate data of the joints acquired by the posture acquisition unit 202 and on which a predetermined transformation such as a linear transformation is performed. In this case, the posture acquisition unit 202 or the selection unit 203 may perform the predetermined transformation on the coordinate data of the joints.

In the present exemplary embodiment, a case is described in which the probability that the object is the main object of the processing target image is adopted as the reliability representing the likeness of the main object (the reliability corresponding to a degree of possibility that the object is the main object of the processing target image), but a value other than the probability may also be used. For example, a reciprocal of a distance between a position of the center of gravity of the object and a position of the center of gravity of an important object in the scene, such as a ball, can be used as the reliability. For example, in a scene of shooting in soccer, since the object that the user is focusing on (a person who is shooting) is expected to be close to the important object, i.e., a soccer ball, the above-described reciprocal can be used to calculate the reliability.

In step S304, the selection unit 203 selects an object with the maximum probability among the detected objects (persons) as the main object candidate. Then, in step S306, the selection unit 203 stores the coordinates of the joints of the main object candidate and representative coordinates representing the main object candidate (a position of the center of gravity, a face position, and the like) in the RAM 154. Accordingly, selection processing is completed. The processing in step S304 may be performed by the determination unit 204.

In the above description, the case is described in which the main object candidate is selected using the posture information of a single frame. However, a configuration may be adopted in which successive frames or a moving image is read, the probability is calculated using time-series posture information, and the main object is determined. In a case where the time-series posture information is used, information about the joint position (the feature point) at each time may be used, or the joint position information at a certain time and information about motion vectors of the joints and the object (feature amounts calculated from the feature points) may be used in combination. In addition, other information can be used as long as the information represents time-series information.

In a case where the selection unit 203 learns calculation of the reliability (the probability), the selection unit 203 can learn a state (a state of a preparatory action) before moving to an important action (an action related to an event to be recorded, detected, or monitored) as a state of the main object. For example, in the case of kicking a ball, a state of raising a leg while trying to kick the ball can be learned as one of the states of the main object. A reason for adopting this configuration is that in a case where an object, which will actually be a main object, takes an important action, it is necessary that the object is accurately determined as the main object, and the image capturing apparatus 100 is controlled in line with the main object. For example, in a case where the reliability (the probability value) corresponding to the main object exceeds a threshold value set in advance, control to record an image or a video (recording control) is automatically started, and thus the user will not miss an important moment to capture an image (a shutter release opportunity). In this case, information about a typical time to the important action (the delay time until the shutter release opportunity) may be used to control the image capturing apparatus 100 based on a state of a learning target. In other words, in a case where the main control unit 151 detects the important action from the object, the main control unit 151 may perform control to complete AF, exposure, and other operations after the typical time corresponding to the detected important action and to perform a main image capturing operation (release a shutter).

### Determination Unit

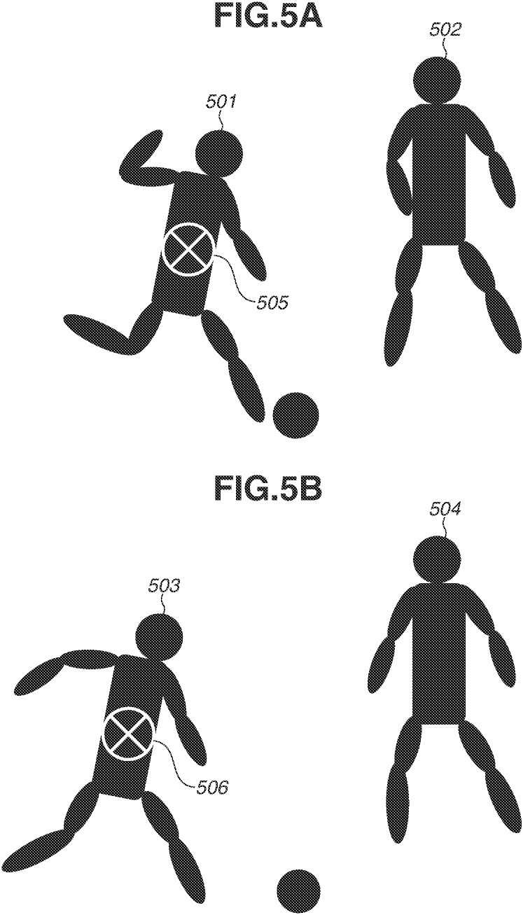

FIGS. 5A and 5B illustrate examples of processing target images in different frames. FIG. 5A illustrates an image (an image of interest) in a frame of interest, and FIG. 5B illustrates an image in a frame M frames before the frame of interest. In a case where the selection unit 203 selects objects 501 and 503, the determination unit 204 calculates a distance between a position 505 of the center of gravity of the object 501 and a position 506 of the center of gravity of the object 503 and determines that the objects 501 and 503 are the same object if the distance is less than a predetermined threshold value. This is because if the matching target time M/f [sec] is sufficiently short, where f is the frame rate [frames per second (fps)], a distance that the object moves during that time is expected to be limited. In FIGS. 5A and 5B, the positions 505 and 506 of the center of gravity are indicated by figures that combine circles and intersecting line segments (an intersecting position of the line segments is regarded as the center of gravity) for the sake of understanding. An actual position of the center of gravity is calculated as a point or an area on coordinates that can be calculated from the positions of the joints in the two-dimensional coordinates described above. In addition, any method that can determine the same object, such as template matching using color or a luminance histogram of an image or matching using partial information about the joints, can be used. In general, there is a low possibility of occlusion occurring in an object of which posture information is detected. Thus, it is possible to provide high matching accuracy with a simple method.

As described above, in the first exemplary embodiment, the image capturing apparatus 100 acquires posture information about each of a plurality of objects detected from a processing target image and selects a main object candidate from among the plurality of objects based on the posture information about each of the plurality of objects. Then, the image capturing apparatus 100 performs the same object determination between the main object candidates detected in frames within a predetermined period of time and determines the main object.

Accordingly, the image capturing apparatus 100 can determine the main object that is highly likely to match a user’s intention in the image in which the plurality of objects exists.

The image capturing apparatus 100 can reduce a processing load by performing matching only once in the main object determination processing and can further improve detection accuracy of the main object by performing the same object determination using information from two or more frames in the main object determination processing.

### Display Unit

An image and a detection result of the main object to be displayed on the display unit 150 are described.

After the above-described main object determination processing is performed based on an instruction from the main control unit 151, the display unit 150 may display an image in which display such as a marker or a frame is superimposed on the determined main object. Superimposition display of a marker, a frame, or the like may be performed not only on the main object but also on the main object candidate. In that case, color, a thickness, a shape, or the like of the marker or the frame may be changed to distinguish between the main object candidate and the determined main object. For example, a thick line frame may be superimposed on the main object, and a thin line frame may be displayed on the main object candidate. The display method is not limited to the example, and any display can be used as long as the user can distinguish between them.

The display of the marker or the frame does not need to wait for the completion of the main object determination processing and can be started when the main object candidate is detected in the image. Meanwhile, in a case where the main object candidate and the main object do not exist in the image, the superimposition display is not necessary.

The user may be able to turn on and off the superimposition display as needed.

In a second exemplary embodiment, a modification of the main object determination processing according to the first exemplary embodiment is described.

In the second exemplary embodiment, a basic configuration of the image capturing apparatus 100 is similar to that according to the first exemplary embodiment (refer to FIG. 1). A difference from the first exemplary embodiment is mainly described below.

In step S307 in FIG. 3, the determination unit 204 performs matching not only with the main object candidate in the closest frame to the Nth frame but also with the main object candidate in all of the N-Mth to N-1th frames recorded in the RAM 154. In a case where the main object candidate is determined as the same object (YES in step S307), the processing proceeds to step S308, and if not (NO in step S307), the processing proceeds to step S309.

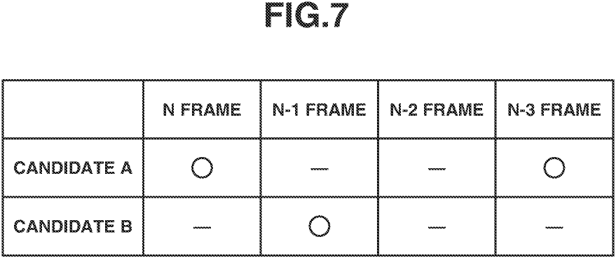

As described above, the matching is performed on the main object candidate in all of the previous M frames, and thus, even if a candidate B is detected while a candidate A is being detected as illustrated in FIG. 7, the candidate A can be determined as the same object.

As described above, in the second exemplary embodiment, even if a different person is detected as the main object candidate, the main object candidate in the previous frames is less likely to be missed, and the detection accuracy of the main object can be improved.

In a third exemplary embodiment, a case is described in which the main object determination processing according to the first and second exemplary embodiments and object tracking processing are performed at the same time.

In the third exemplary embodiment, a basic configuration of the image capturing apparatus 100 is similar to that according to the first and second exemplary embodiments (refer to FIG. 1). A difference from the first exemplary embodiment is mainly described below.

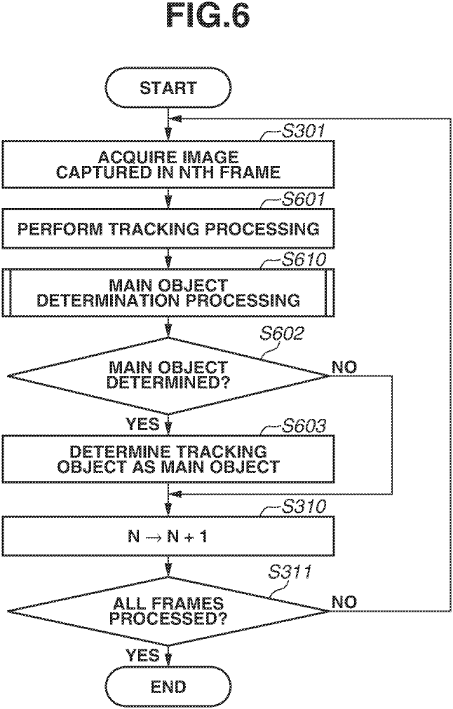

FIG. 6 is a flowchart illustrating processing according to the present exemplary embodiment. In step S601, the posture acquisition unit 202 detects, in the Nth frame, the same object as the object (tracking object) that the tracking unit of the image processing unit 152 has been tracking up to the N-1th frame.

Step S610 represents steps S303 to S309 in FIG. 3, and the main object determination processing described in the first exemplary embodiment is performed therein. In step S602, it is determined whether the main object is determined in step S610. In a case where the main object is determined (YES in step S602), then in step S603, the tracking object is changed to the main object determined in step S610. In a case where the main object determined in step S610 is the same as the tracking object, the tracking object is not changed.

As described above, in the third exemplary embodiment, the main object that is highly likely to match the user’s intention can be determined from a plurality of objects even during the tracking processing, and the main object can be further tracked.

In the present exemplary embodiment, the example is described in which the imaging element 141 of the image capturing apparatus 100 is fixed to a main body, and the object is tracked within the same angle of view. However, each of the exemplary embodiments is not limited to the example, and the image capturing apparatus 100 may be configured to include pan, tilt, and zoom driving mechanisms and to track the object while performing at least one of pan, tilt, and zoom operations in response to a movement of the object.

In a fourth exemplary embodiment, a modification of the main object determination processing according to the first to third exemplary embodiments is described. In the present exemplary embodiment, the main object determination processing is performed on a plurality of objects using evaluation of the probability value indicating the likeness of the main object and matching using a plurality frames in combination. Accordingly, in a case where there is a plurality of objects that are highly likely to be the main object, such as in a duel in soccer, it is possible to improve the accuracy of the main object determination processing while preventing the main object candidate from being missed.

In the fourth exemplary embodiment, a basic configuration of the image capturing apparatus 100 is similar to that according to the first exemplary embodiment (refer to FIG. 1). The fourth exemplary embodiment is described below mainly in line with the first exemplary embodiment.

In the present exemplary embodiment, the same processing as that in steps S301 to S303 in FIG. 3 according to the first exemplary embodiment is performed.

In step S304, the selection unit 203 selects an object that has the maximum value of the probability representing the likeness of the main object as well as an object having a value of the probability that is different from the maximum value of the probability by less than a predetermined value as the main object candidates.

In step S305, the determination unit 204 refers to the information in the RAM 154 and determines whether the main object candidates exist in the images in the N-Mth to N-1th frames. In a case where the main object candidates exist (YES in step S305), the processing proceeds to step S306, whereas in a case where the main object candidates do not exist (NO in step S305), the processing proceeds to step S309. In step S306, the same processing as that according to the first exemplary embodiment is performed.

In step S307, the determination unit 204 performs the matching with respect to all the main object candidates recorded in the RAM 154 in the images in the N-Mth to N-1th frames. In a case where one of the main object candidates is determined as the same object (YES in step S307), the processing proceeds to step S308, and if not (NO in step S307), the processing proceeds to step S309. In the first to third exemplary embodiments, the same object determination in step S307 is performed based on a condition that the same object is determined in the frame of interest and in another frame, but may be performed based on a condition that a match is found in the frame of interest and in two or more other frames. A means of storing a plurality of main object candidates and a means of applying the strict condition for the same object determination may be performed at the same time, or either one may be performed. By applying the strict condition for the same object determination, it is possible to prevent a decrease in the accuracy of the same object determination even in a situation in which there are many main object candidates.

As described above, in the fourth exemplary embodiment, in a case where there is a plurality of objects that are highly likely to be the main object in a screen, it is possible to improve accuracy of object selection while preventing the main object candidates from being missed.

The present disclosure can also be realized by processing in which a program for implementing one or more functions of the above-described exemplary embodiments is supplied to a system or an apparatus via a network or a storage medium and one or more processors in a computer of the system or the apparatus reads and executes the program. Further, the present disclosure can also be realized by a circuit (for example, an application specific integrated circuit (ASIC)) for implementing one or more functions of the above-described exemplary embodiments.

The present disclosure is not limited to the above-described exemplary embodiments, and various modifications and changes can be made without departing from the spirit and the scope of the present disclosure.

According to the present disclosure, it is possible to accurately determine a main object that is highly likely to match a user’s intention in an image in which a plurality of objects exists.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-198650, filed Dec. 7, 2021, which is hereby incorporated by reference herein in its entirety.

What is claimed is:

1. A main object determination apparatus comprising:
one or more processors; and
a memory storing instructions which, when executed by the one or more processors, cause the main object determination apparatus to function as:
an acquisition unit configured to acquire images captured at different timings;
a selection unit configured to select a candidate of a main object from among objects using information about a feature point of each object in the images; and
a determination unit configured to determine whether candidates of the main object selected at the different timings are the same using information about a feature amount calculated from the feature point,
wherein the main object is determined in a case where the determination unit determines that the candidates of the main object selected by the selection unit in an image of interest and in at least one image captured within a predetermined period of time before the image of interest is captured are the same.

2. The main object determination apparatus according to claim 1, wherein the object refers to a person or an animal.

3. The main object determination apparatus according to claim 1, wherein the feature point is at least one joint position in the object.

4. The main object determination apparatus according to claim 1, wherein the information about the feature amount is a center of gravity of the object, position information indicating a part of a body of the object, or a position or motion vector of the object calculated from the feature point.

5. The main object determination apparatus according to claim 1, wherein the selection unit calculates reliability corresponding to a degree of possibility of being a main object for each of the objects.

6. The main object determination apparatus according to claim 5, wherein the selection unit uses a distance between the object and an important object to calculate the reliability.

7. The main object determination apparatus according to claim 5, wherein the selection unit selects an object having a maximum value of the reliability as the candidate of the main object.

8. The main object determination apparatus according to claim 7, wherein the selection unit also selects an object having a value of the reliability different from the maximum value of the reliability by less than a predetermined value as the candidate of the main object.

9. The main object determination apparatus according to claim 1, further comprising a tracking unit configured to track the objects,
wherein, in a case where the determination unit determines that the candidates of the main object are the same, the tracking unit changes a tracking target in the image of interest to the main object.

10. The main object determination apparatus according to claim 1, wherein the selection unit does not select the candidate of the main object from an image that is not captured within the predetermined period of time before the image of interest is captured.

11. An image capturing apparatus comprising:
an image capturing unit configured to capture an object image formed via an imaging optical system; and
the main object determination apparatus according to claim 1.

12. A method for controlling a main object determination apparatus, the method comprising:
acquiring images captured at different timings;
selecting a candidate of a main object from among objects using information about a feature point of each object in the images; and
determining whether candidates of the main object selected at the different timings are the same using information about a feature amount calculated from the feature point,
wherein the main object is determined in a case where the selected candidates of the main object in an image of interest and in at least one image captured within a predetermined period of time before the image of interest is captured are determined as the same.

13. A non-transitory computer-readable storage medium storing a program for causing a computer to execute each process in the method according to claim 12.

14. A main object determination apparatus comprising:
one or more processors; and
a memory storing instructions which, when executed by the one or more processors, cause the main object determination apparatus to function as:
an acquisition unit configured to acquire images captured at different timings;
a selection unit configured to select a candidate of a main object from among objects in the images; and
a determination unit configured to determine whether candidates of the main object selected at the different timings are the same,
wherein the main object is determined in a case where the selection unit selects the candidate of the main object in at least one image captured within a predetermined period of time before an image of interest is captured and the determination unit determines that the candidate of the main object in the image captured within the predetermined period of time is the same as the candidate of the main object in the image of interest.

15. The main object determination apparatus according to claim 14, wherein the selection unit calculates reliability corresponding to a degree of possibility of being a main object for each of the objects.

16. The main object determination apparatus according to claim 15, wherein the selection unit uses a distance between the object and an important object to calculate the reliability.

17. The main object determination apparatus according to claim 15, wherein the selection unit selects an object having a maximum value of the reliability as the candidate of the main object.

18. The main object determination apparatus according to claim 17, wherein the selection unit also selects an object having a value of the reliability different from the maximum value of the reliability by less than a predetermined value as the candidate of the main object.

19. The main object determination apparatus according to claim 14, further comprising a tracking unit configured to track the objects,
wherein, in a case where the determination unit determines that the candidates of the main object are the same, the tracking unit changes a tracking target in the image of interest to the main object.

20. The main object determination apparatus according to claim 14, wherein the selection unit does not select the candidate of the main object from an image that is not captured within the predetermined period of time before the image of interest is captured.

21. An image capturing apparatus comprising:
an image capturing unit configured to capture an object image formed via an imaging optical system; and
the main object determination apparatus according to claim 14.

22. A method for controlling a main object determination apparatus, the method comprising:
acquiring images captured at different timings;
selecting a candidate of a main object from among objects in the images; and
determining whether candidates of the main object selected at the different timings are the same,
wherein the main object is determined in a case where the candidate of the main object is selected in at least one image captured within a predetermined period of time before an image of interest is captured, and the candidate of the main object in the image captured within the predetermined period of time is determined as the same as the candidate of the main object in the image of interest.

23. A non-transitory computer-readable storage medium storing a program for causing a computer to execute each process in the method according to claim 22.
